(19) United States
(12) Patent Application Publication
(10) Pub. No.: US 2025/0005609 A1
(43) Pub. Date: Jan. 2, 2025

(54) GENERATIVE TRANSFORMER MODELS FOR DETERMINING PRODUCT PREDICTIONS

(71) Applicant: The Boston Consulting Group, Inc., Boston, MA (US)

(72) Inventors: Adam Whybrew, Petersham (AU); Arun Karthik Ravindran, Somerville, MA (US); Manaswi Veligatla, Melbourne (AU)

(21) Appl. No.: 18/345,200

(22) Filed: Jun. 30, 2023

(51) Int. Cl. G06Q 30/0202; G06Q 10/087

(52) U.S. Cl. CPC G06Q 30/0202; G06Q 10/087

(57) ABSTRACT

In an example method, a system receives a first data set representing a plurality of first purchases of a plurality of first products by a plurality of first users, and trains a generative transformer model including one or more computerized attention mechanisms using the first data set as an input. Further, the system receives a second data set representing one or more second products selected by a second user for purchase, and provides the second data set to the generative transformer model. The system outputs a third data set generated by the generative transformer model based on the second data set, where the third data set represents a prediction of one or more third products for purchase by the second user, and stores the third data set using one or more computer storage devices.

### TECHNICAL FIELD

The disclosure relates to systems and methods for implementing a generative transformer models for determining product predictions, such as determining product recommendations based on a customer's current or previous purchases.

### BACKGROUND

In general, a person can purchase products from a merchant.

As an example, a person can browse products at a physical storefront, select products for purchase, and depart the physical storefront with the purchased items.

As another example, a person can browse products at an online storefront (e.g., a website), select products for purchase (e.g., by placing the products into a virtual “shopping cart”), and have the purchased items shipped to her location.

### SUMMARY

In general, a computer system can be configured to generate product predictions using a generative transformer model.

As an example, the computer system can implement a generative transformer model having one or more computerized attention mechanisms. Further, the computer system can train the generative transformer model to generate one or more product predictions based on input data that identifies one or more products.

For instance, the computer system can generate a training data set representing several purchases made by a first group of users. In particular, the training data set can include several data strings, each having a respective sequence of tokens. Each of the data strings can represent a respective one of the purchases made by the users. Further, each of the tokens can represent a respective one of the products that were purchased by the users.

Based on the training data, the computer system identifies trends and/or correlations between the products and purchases, and configures the generative transformer model to generate product predictions based on input data identifying one or more products. For instance, the generative transformer model can generate product recommendations based on a customer's current or previous purchases.

As an example, the computer system can receive an input data set representing one or more products that have been selected by a user for purchase. The input data set can include an input data string having one or more tokens. Each of the tokens can represent a respective one of the products that have been selected by the user. The computer system provides the input data set to the generative transformer model, and receives output an output data set from the generative transformer model representing one or more predicted products (e.g., one or more data strings having one or more tokens that represent the predict products). The computer system can present at least some of the predicted products to the user (e.g., to encourage the user to purchase those products). Further, the computer system can save at least a portion of the output data set for further retrieval and/or processing.

The systems and techniques described herein can be used to facilitate purchase by users in various ways.

As an example, the generative transformer model can receive input data indicating one or more products that were selected by a user for purchase, and recommend additional products for the user to purchase in the same transaction.

As another example, the generative transformer model can receive input data indicating one or more products that were previously purchased by a user, and recommend additional products for the user to purchase in a future transaction.

As another example, the generative transformer model can receive input data indicating the purchases made by several users, and predict a future demand for products by those users (e.g., by predicting that the users will purchase certain products in the future, based on their previous purchase history).

The implementations described in this disclosure can provide various technical benefits. For instance, in some implementations, the systems and techniques described herein can be performed to automatically identify product recommendations and/or relationships between products. This allows users to make purchases in a more efficient and/or effective manner.

For example, a user can select products for purchase at an online merchant. Based on this selection, a generative transformer model can automatically identify additional products that complement and/or supplement the user's selection, and provide the recommendation to the user such that the user can purchase those additional products in the same transaction. Further, this allows the user to consider products that she previously was not aware of (or otherwise forgot about). This allows the user to make her purchase more efficiently, for example, by reducing the amount of time that the user spends browsing the online merchant's website for products. Thus, the amount of computer resources (e.g., computer processor utilization, network utilization, memory utilization, power utilization, etc.) that are expended by the user and/or the online merchant are reduced.

As another example, using the system and techniques described herein, a merchant can purchase and maintain a stock of products and sell those products in a more efficient and/or effective manner. For instance, a merchant can more effectively anticipate the types and/or amounts of products that users will purchase in the future (e.g., based on their previous purchases), and can purchase and maintain a stock of products to meet the anticipated demand. Further, the based on this information, the merchant can reduce stock in products that are anticipated to have a lower demand. Accordingly, the merchant can utilize limited resources (e.g., warehouse space, shipping and transportation resources, etc.) in a more efficient manner.

Further, the systems and techniques described herein can be performed by a computer system using computer-specific techniques to achieve a result that otherwise would require subjective input from a human. For example, a computer system can perform these techniques using a generative transformer model (e.g., having one or more attention mechanisms) to generate product predictions in an objective manner. Absent these techniques, a human would subjectively review data regarding users' purchases, and predict additional products (e.g., product recommendations) based on subjective factors and considerations. This may result in product predictions that are less effective than those generated by a generative transformer model. Further, absent these techniques, a human's subjective review of the data may produce inconsistent and/or unpredictable results (e.g., compared to those that are generated by a computer system using a generative transformer model).

In an aspect, a method includes: receiving, by one or more processors, a first data set representing a plurality of first purchases of a plurality of first products by a plurality of first users, where the first data set includes a plurality of first data strings, each having a respective sequence of first tokens, where each of the first data strings represents a respective one of the first purchases, and where each of the first tokens represents a respective one of the first products; training, by the one or more processors, a generative transformer model including one or more computerized attention mechanisms using the first data set as an input; receiving, by one or more processors, a second data set including a second data string representing one or more second products selected by a second user for purchase, where the second data string includes one or more second tokens, and where each of the one or more second tokens represents a respective one of the one or more second products; providing, by the one or more processors, the second data set to the generative transformer model; outputting, by the one or more processors, a third data set generated by the generative transformer model based on the second data set, where the third data set represents a prediction of one or more third products for purchase by the second user; and storing, by the one or more processors, the third data set using one or more computer storage devices.

Implementations of this aspect can include one o more of the following features.

In some implementations, the plurality of first users can include the second user.

In some implementations, the third data set can include a third data string, where the third data string includes one or more third tokens, and where each of the one or more third tokens represents a respective one of the one or more third products.

In some implementations, at least one of the first tokens, the one or more second tokens, or the one or more third tokens can include a identifier representing a stock keeping unit (SKU) associated with a respective one of the first products, the one or more second products, or the one or more third products.

In some implementations, at least one of the first tokens, the one or more second tokens, or the one or more third tokens can include a respective token indicating a beginning of at least one of the first data strings, the one or more second data strings, or the one or more third data strings.

In some implementations, at least one of the first tokens, the one or more second tokens, or the one or more third tokens can include a respective token indicating an end of at least one of the first data strings, the one or more second data strings, or the one or more third data strings.

In some implementations, for each of the first data strings, the first tokens of that first data string can be arranged randomly.

In some implementations, for each of the first data strings, the first tokens of that first data string can be arranged sequentially according to one or more first characteristics.

In some implementations, the one or more first characteristics can include at least one of: a price of a respective one of the first products, a purchase frequency of a respective one of the first products by the first users, a purchase frequency of a respective one of the first products by a respective one of the first users, or an order in which of a respective one of first products was selected for purchase by a respective one of the first users.

In some implementations, the first data set can include first embedded data representing a respective time at which each of the first products was purchased by the first users.

In some implementations, the first tokens can include the embedded data.

In some implementations, the embedded data and the first tokens can be represented by different respective data structures.

In some implementations, the second data set can represent one or more second products selected by the second user for purchase at an on-line merchant.

In some implementations, the second data set can represent one or more second products selected by the second user for purchase at a physical merchant.

In some implementations, the method can also include causing a message to be presented to the second user, where the message includes an indication of at least some of the one or more third products.

In some implementations, the method can also include estimating, based on the third data set, a future stock level of the one or more third products.

In some implementations, the method can also include: receiving a fourth data set, where the fourth data set represents one or more fourth products; providing the fourth data set to the generative transformer model; obtaining a fifth third data set generated by the generative transformer model based on the fourth data set, where the fifth data set represents a prediction of one or more fifth products that are related to the one or more fourth products; and storing the fifth data set using one or more hardware storage devices.

In some implementations, the one or more fourth products can be a subset of the one or more second products.

In some implementations, the one or more computerized attention mechanisms can include one or more decoders.

In some implementations, the one or more computerized attention mechanisms can include one or more decoders and one or more encoders.

Other implementations are directed to systems, devices, and devices for performing some or all of the method. Other implementations are directed to one or more non-transitory computer-readable media including one or more sequences of instructions which when executed by one or more processors causes the performance of some or all of the method.

The details of one or more embodiments are set forth in the accompanying drawings and the description. Other features and advantages will be apparent from the description and drawings, and from the claims.

### BRIEF DESCRIPTION OF DRAWINGS

FIG. 1 is a diagram of an example system for generating product predictions using a generative transformer model.

FIG. 2 is a diagram showing an example operation of a product prediction engine.

FIG. 3 is a diagram of an example product prediction engine.

FIG. 4 is a flow chart diagram of an example process for generating product predictions using a generative transformer model.

FIG. 5 is a schematic diagram of an example computer system.

### DETAILED DESCRIPTION

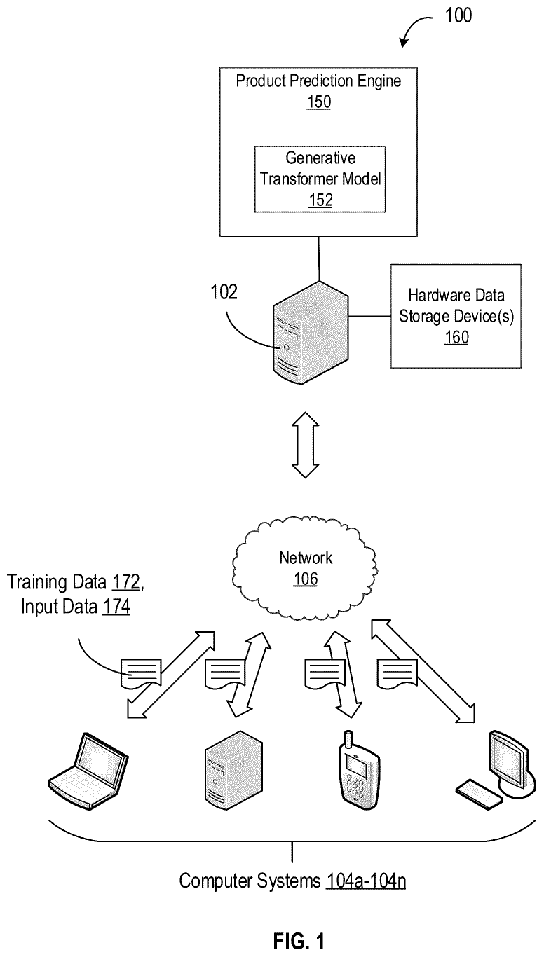

FIG. 1 shows an example system 100 for generating product predictions. The system 100 includes a product prediction engine 150 maintained on a computer system 102. The product prediction engine 150 includes a generative transformer model 152 that is trained to generate product predictions based on input data (e.g., input data representing one or more products selected for purchase by a user).

During an example operation of the system 100, the product prediction engine 150 receives training data 172 from one or more computer systems 104a-104n via a network 106.

At least some of the training data 172 can represent several purchases made by a first group of users. For example, the training data 172 can identify several transactions made by the first group of users (e.g., with one or more merchants), the products that were purchased during each of the transactions, and the users that performed each of the transactions.

In some implementations, the training data 172 can include several data strings, each having a respective sequence of tokens. Each of the data strings can represent a respective one of the purchases made by the users (e.g., during a single transaction). Further, each of the tokens can represent a respective one of the products that were purchased by the users (e.g., during that transaction).

In general, a token is a series of characters (e.g., alphanumeric characters) that uniquely identifies a product from among a collection of products. In some implementations, a token can be (or otherwise include) a unique alphanumeric identifier products, such as a stock keeping unit (SKU) that has been assigned to that product (e.g., by a user and/or computer system managing an inventory of products).

Further, in at least some implementations, a token does not include a narrative description of the product itself. For example, a carton of eggs could be represented by a SKU (e.g., a serial number “01924335”) rather than a narrative description such as “One Dozen Eggs.”

In some implementations, a data string can also include one or more additional tokens representing additional information regarding a purchase and/or a selection of items by a user. In some implementations, these tokens can be identified using different respective identifiers (e.g., an identifier unique to each type of token).

As an example, a data string can include one or more tokens indicating the beginning of a set of selected items (e.g., a “start of basket” token) and/or an end of the set of selected items (e.g., a “end of basket” token). For instance, the “start of basket” token can indicate that the subsequent tokens in the data string (e.g., until the end of the data string, or until the “end of basket” token) represents products that were selected for purchase during a single transaction.

As another example, a data string can include one or more tokens indicating the beginning of a particular time interval (e.g., a day, a week, a month, or any other time interval). For instance, the token can indicate that the subsequent tokens in the data string (e.g., until the end of the data string, or until the next token indicating a different time interval) represents products that were selected for purchase during the same time interval.

As another example, a data string can include one or more tokens indicating a particular customer. For instance, the token can indicate that the subsequent tokens in the data string (e.g., until the end of the data string, or until the next token indicating a different customer) represents products that were selected for purchase by the same customer.

In some implementations, at least some of the training data 172 can be received from one or more computer system associated with a merchant. For example, at least some of the training data 172 can be received from computer systems maintaining transaction records for a merchant (e.g., records detailing purchases made by customers at the merchant). In some implementations, at least some of the training data 172 can be received from one or more computer system associated with the users that performed the transactions (e.g., the users' personal devices, such as a smartphone, tablet, computer, etc.).

Based on the training data 172, the product prediction engine 150 identifies trends and/or correlations between the products and purchases made by the first group of users, and configures the generative transformer model 152 to generate product predictions based on input data 174 identifying one or more products.

As an example, the product prediction engine 150 can receive input data 174 representing one or more products that have been selected by a user for purchase (e.g., physically selected by a user and/or electronically selected by a user, such as by placing the product in a virtual or electronic “shopping cart”). The input data 174 can include an input data string having one or more tokens. Further, each of the tokens can represent a respective one of the products that have been selected by the user (or other information regarding a purchase). In general, input data strings and its constituent tokens can be similar to the data strings and tokens described with reference to the training data 172.

The product prediction engine 150 provides the input data 174 to the generative transformer model 152, and receives output an output data set from the generative transformer model 154 representing one or more predicted products (e.g., one or more data strings having one or more tokens that represent the predicted products). In general, data strings of the output data set and its constituent tokens can be similar to the data strings and tokens described with reference to the training data 172.

Further, the generative transformer model 154 can output a probability metric for each of the data strings (e.g., indicating the probability or the confidence that the data string represents the user's preferences and/or the products that the user will actually purchase in the future).

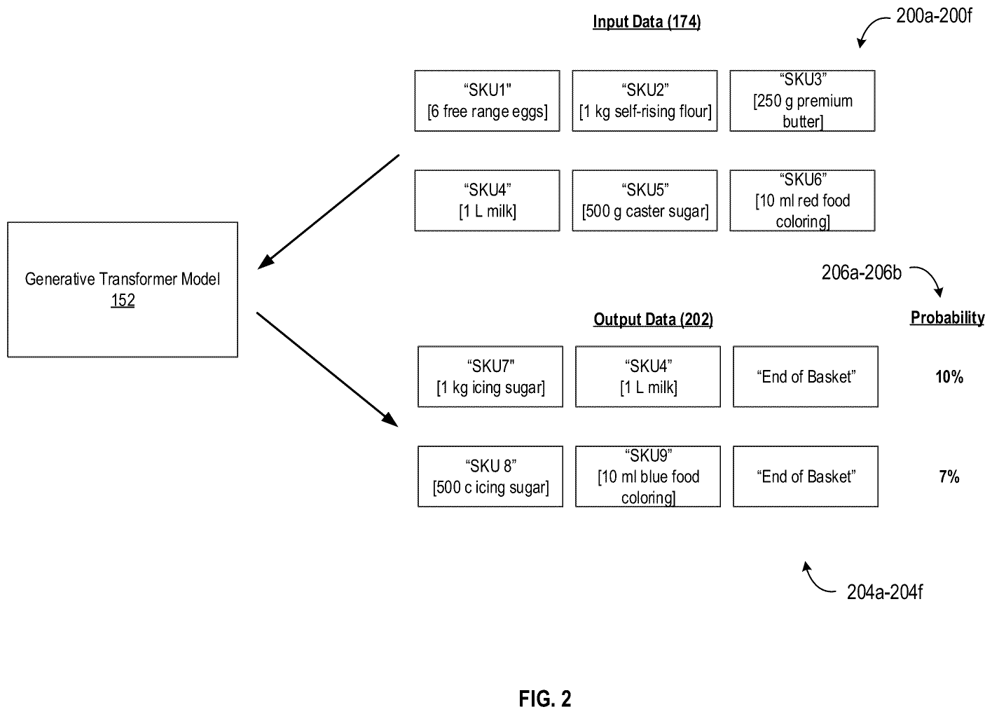

As an illustrative example, FIG. 2 shows input data 174 (e.g., a data string) representing several items that have been selected for purchase by a user. The input data 174 includes several tokens 200a-200f. For example, each of the tokens 200a-200f can indicate a respective SKU that represents the product shown in brackets. However, in at least some implementations, the tokens 200a-200f do not include any narrative descriptions of the products.

Based on the input data 174, the generative transformer model 152 generates output data 202 (e.g., one or more data strings) representing one or more predicted products. The output data 202 includes several tokens 204a-204f. For example, at least some of the tokens 204a-204f can indicate a respective SKU that represents the predicted product shown in brackets. However, in at least some implementations, the tokens 204a-204f do not include any narrative descriptions of the predicted products. In this example, the output data 202 includes two data strings, each having two tokens and an “end of basket” token (e.g., indicating the end of the data string and the end of a single sequence of predicted products).

Further, the generative transformer model 152 generates probability metrics 206a and 206b for the data strings (e.g., indicating the probability or the confidence that the data string represents the user's preferences and/or the products that the user will actually purchase in the future).

In some implementations, the product prediction engine 150 can present at least some of the predicted products to the user (e.g., to encourage the user to purchase those products). For example, the product prediction engine 150 can transmit a message to a user (e.g., an email message, data message, chat message, telephone call, physical flyer or letter, etc.) identifying at least some of the predicted products specified in the output data 202. As another example, the product prediction engine 150 can represent a graphical user interface (e.g., on a webpage, application, etc.) identifying at least some of the predicted products specified in the output data 202.

In some implementations, the product prediction engine 150 can present at least some of the predicted products to the user by selecting the data string in the output data 202 having the highest probability metric. Further, the product prediction engine 150 can present at least some of the products identified in the selected data string.

In some implementations, the product prediction engine 150 can present at least some of the predicted products to the user by sampling the probability distribution of product predictions, and selecting one or more of the predicted products based on the sampled probability distribution (e.g., the selected products can, but need not be the products having the highest probability metric). Further, the product recommendation prediction engine 150 can present at least some of the products identified in the selected data string.

In some implementations, the product prediction engine 150 can save at least a portion of the output data 202 for further retrieval and/or processing (e.g., using one or more hardware data storage devices 160 of the computer system 102).

The system 100 can be used to facilitate purchase by users in various ways.

As an example, the product prediction engine 150 can receive input data indicating one or more products that were selected by a user for purchase, and recommend additional products for the user to purchase in the same transaction.

As another example, the product prediction engine 150 can receive input data indicating one or more products that were previously purchased by a user, and recommend additional products for the user to purchase in a future transaction.

As another example, the product prediction engine 150 can receive input data indicating the purchases made by several users, and predict a future demand for products by those users (e.g., by predicting that the users will purchase certain products in the future, based on their previous purchase history).

As another example, the product prediction engine 150 can receive input data indicating a first set of products, and determine a second set of products that are related to the first set of products (e.g., products that complement, supplement, and/or replace the first set of products). For example, the first set of products can include products in a user's possession (e.g., food items in a pantry), and the second set of products can include products that complement, supplement, and/or replace the first set of products (e.g., additional food items that can be used instead of or in combination with the food items in the pantry).

As another example, the product prediction engine 150 can receive input data indicating one or more products that were selected for purchase by a user, and predict what the user will purchase in a future transaction. Further, the product prediction engine 150 can insert one or more additional products from the input data and/or remove one or more products from the input data, and predict how those changes will affect the user's future purchases.

In general, each of the computer systems 102 and 104a-104n can include any number of electronic devices that are configured to receive, process, and transmit data. Examples of the computer systems include client computing devices (e.g., desktop computers or notebook computers), server computing devices (e.g., server computers or cloud computing systems), mobile computing devices (e.g., cellular phones, smartphones, tablets, personal data assistants, notebook computers with networking capability), wearable computing devices (e.g., smart phones or headsets), and other computing devices capable of receiving, processing, and transmitting data. In some implementations, the computer systems can include computing devices that operate using one or more operating systems (e.g., Microsoft Windows, Apple macOS, Linux, Unix, Google Android, and Apple IOS, among others) and one or more architectures (e.g., x86, PowerPC, and ARM, among others). In some implementations, one or more of the computer systems need not be located locally with respect to the rest of the system 100, and one or more of the computer systems can be located in one or more remote physical locations.

Each the computer systems 102 and 104a-104n can include a respective user interface that enables users interact with the computer system, other computer systems, and/or the product prediction engine 150. Example interactions include viewing data, transmit data from one computer system to another, and/or issuing commands to a computer system. Commands can include, for example, any user instruction to one or more of the computer system to perform particular operations or tasks. In some implementations, a user can install a software application onto one or more of the computer systems to facilitate performance of these tasks.

In FIG. 1, the computer systems 102 and 104a-104n are illustrated as respective single components. However, in practice, the computer systems 102 and 104a-104n can be implemented on one or more computing devices (e.g., each computing device including at least one processor such as a microprocessor or microcontroller). As an example, the computer system 102 can be a single computing device that is connected to the network 106, and the product prediction engine 150 can be maintained and operated on the single computing device. As another example, the computer system 102 can include multiple computing devices that are connected to the network 106, and the product prediction engine 150 can be maintained and operated on some or all of the computing devices. For instance, the computer system 102 can include several computing devices, and the product prediction engine 150 can be distributed on one or more of these computing devices.

The network 106 can be any communications network through which data can be transferred and shared. For example, the network 106 can be a local area network (LAN) or a wide-area network (WAN), such as the Internet. The network 106 can be implemented using various networking interfaces, for instance wireless networking interfaces (such as Wi-Fi, Bluetooth, or infrared) or wired networking interfaces (such as Ethernet or serial connection). The network 106 also can include combinations of more than one network, and can be implemented using one or more networking interfaces.

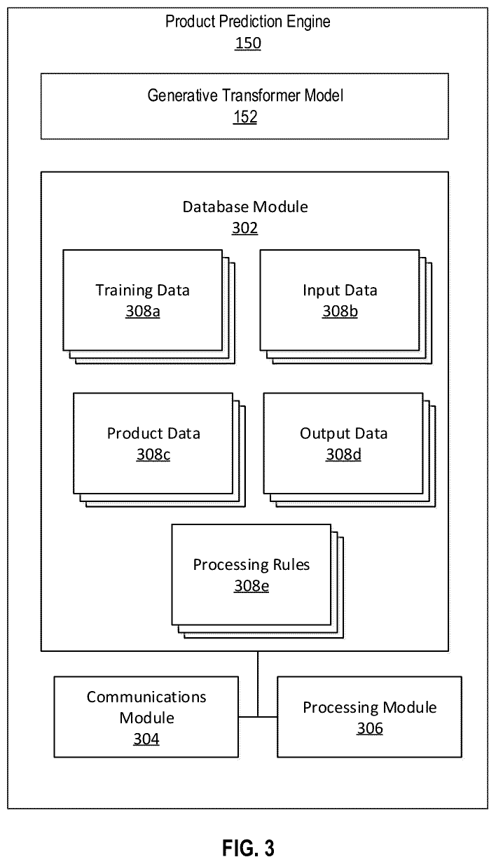

FIG. 3 shows various aspects of the product prediction engine 150. In general, the product prediction engine 150 includes several operation modules that perform particular functions related to the operation of the product prediction engine 150. For example, the product prediction engine 150 includes a generative transformer model 152. Further, the product prediction engine 150 includes a database module 302, a communications module 304, and a processing module 306. The operation modules can be provided as one or more computer executable software modules, hardware modules, or a combination thereof. For example, one or more of the operation modules can be implemented as blocks of software code with instructions that cause one or more processors of the product prediction engine 150 to execute operations described herein. In addition or alternatively, one or more of the operations modules can be implemented in electronic circuitry such as, e.g., programmable logic circuits, field programmable logic arrays (FPGA), or application specific integrated circuits (ASIC).

The database module 302 maintains information related to generating product predictions using the generative transformer model 152.

As an example, the database module 302 can store training data 308a for training the generative transformer model 152. The training data 308a can be similar to the training data 172 described with reference to FIG. 1. For example, the training data 308a can represent several purchases made by a first group of users (e.g., in the form of one or more data strings, each having one or more tokens).

As another example, the database module 302 can store input data 308b that is used as an input to the generative transformer model 152. The input data 308b can be similar to the input data 174 described with reference to FIGS. 1 and 2. For example, the input data 308b can represent one or more products that one or more users have selected for purchase (e.g., in the form of one or more data strings, each having one or more tokens).

As another example, the database module 302 can store product data 308c regarding a collection of products. As an example, the product data 308c can include information regarding each of the products that are offered for sale by one or more merchants. For each of the products, the product data 308c can include a name or narrative description of the product, and a unique identifier associated with the product (e.g., a SKU). In some implementations, the product data 308c can also include additional information regarding a product, such as the price of the product, and/or the location of the product (e.g., at a particular storefront or warehouse, and/or at a specific location within that storefront or warehouse). As further examples, the product data 308c can include stock information (e.g., an inventory level) of the product.

As another example, the database module 302 can store output data 308d generated by the generative transformer model 152. The output data 308d can be similar to the output data 202 described with reference to FIGS. 1 and 2. For example, the output data 308d can represent one or more predicted products for one or more users (e.g., in the form of one or more data strings, each having one or more tokens). For instance, at described above, the output data 308 can represent one or more recommended products for the one or more users to purchase.

Further, the database module 302 can store processing rules 308e specifying how data in the database module 302 can be processed to determine one or more predicted products using the generative transformer model 152.

As another example, the processing rules 308e can include one or more rules for generating the training data 308a. For instance, one or more rules can specify that historical transaction information (e.g., from one or more merchants) be converted into one or more data strings, each having one or more tokens. The conversion can be performed based on the product data 308c (e.g., by identifying each of the products in the historical transaction information, and determining corresponding unique identifiers associated with those products).

As another example, the processing rules 308e can include one or more rules for generating the input data 308b. For instance, one or more rules can specify that information regarding a user's product selections be converted into one or more data strings, each having one or more tokens. The conversion also can be performed based on the product data 308c (e.g., by identifying each of the products, and determining corresponding unique identifiers associated with those products).

As another example, the processing rules 308e can include one or more rules for implementing, training, and operating the generative transformer model 152 to produce the output data 308d. For example, the one or more rules can specify that the training data 308a be provided to the generative transformer model 152 for training (e.g., such that the generative transform model 152 can identify trends and/or correlations between the products and purchases made by the first group of users, and generate output based on those identified trends and/or correlations).

As another example, the one or more rules can specify that the input data 308b be provided to the generative transformer model 152 (e.g., to generate output data 308d representing one or more predicted products for a user).

As another example, the one or more rules can specify that the generated output 308d be presented to the user and/or stored for future retrieval and/or processing (e.g., using the database module 302).

Example data processing techniques are described in further detail below.

As described above, the product prediction engine 150 also includes a communications module 304. The communications module 304 allows for the transmission of data to and from the product prediction engine 150. For example, the communications module 304 can be communicatively connected to the network 106, such that it can transmit data to and receive data from each of the computer systems 104a-104n. Information received from these computer systems can be processed (e.g., using the processing module 306) and stored (e.g., using the database module 302).

As described above, the product prediction engine 150 also includes a processing module 306. The processing module 306 processes data stored or otherwise accessible to the product prediction engine 150. For instance, the processing module 206 can be used to execute one or more of the operations described herein (e.g., operations associated with the generative transformer model 152).

In some implementations, a software application can be used to facilitate performance of the tasks described herein. As an example, an application can be installed on the computer systems 102 and/or 104a-104n. Further, a user can interact with the application to input data and/or commands to the product prediction engine 150, and review data generated by the product prediction engine 150.

As described above, the generative transformer model 152 can receive input data presenting one or more products that have been selected for purchase by a user. Further, the generative transformer model 152 can generate output data representing one or more predicted products. The input data and the output data can include one or more data strings, each having one or more tokens representing respective products. In practice, the order of tokens in a data string can vary, depending on the implementations. As an example, the order of the tokens in a data string can be random. As another example, the order of the tokens in a data string can be determined based on a price of each of the products (e.g., sorted from highest price to lowest price, or vice versa). As another example, the order of the tokens in a data string can be determined based on the frequency in which each of the products is purchased by one or more users (e.g., sorted from highest price to lowest price, or vice versa). As another example, the order of the tokens in a data string can be determined based on the order in which each of the products is purchased by one or more users (e.g., sorted from earliest to the most recent, or vice versa).

In some implementations, the product prediction engine 150 can encode position information in each of the tokens that indicates a particular transaction that is associated each of the products. For example, for each of the products that were selected by a user during the same transaction, the respective tokens can each have the same encoded position information. As another example, for products that were selected by a user during different transactions, the respective tokens can have different encoded position information.

In some implementations, the product prediction engine 150 can embed additional information in each of the tokens (e.g., in addition to the encoded position information). As an example, the product prediction engine 150 can embed information in a token indicating the time that a product as purchased (e.g., time of day, day of week, week, month, year, etc.), the merchant at which the product was purchased, or any other information regarding a product and/or a purchase. This additional embedded information can be beneficial, for example, in allowing the product prediction engine 150 to predict products based on additional contextual information regarding each of the products and/or purchases (e.g., to improve the effectiveness of the predictions in a wide array of contexts).

In some implementations, this additional embedded information can be included in the token itself. For example, the embedded information can be combined with the token's SKU (e.g., via concatenation), and fed into feed-forward layers of the generative transformer model 152.

In some implementations, this additional embedded information can be included in a data structure that is separate from the token. For example, the embedded information can be represented by one or more data vectors separate from the tokens.

In some implementations, when the tokens in a data string (e.g., representing a single transaction) are sorted randomly, the product prediction engine 150 can use a loss function (e.g., such as cross entropy or Kullback-Leibler Divergence) in which the target probability distribution is not one-hot encoded when being trained to predict the next item in a transaction which has more than one item remaining in it. Instead, the product prediction engine 150 can take the value 1/n for the n remaining items in the transaction, and 0 otherwise.

In some implementations, the product prediction engine 150 can generate output data that represents a predicted embedding of the next product in a transaction (rather than probabilities of tokens representing it). This can be performed by using a loss function that is based on the distance between the embedding of a product and the embedding of the correct next product. This allows the product prediction engine 150 to predict purchases of items that were not present in the training data (e.g., new products) as long as an embedding was available for them.

### Example Generative Transformer Models

In general, the generative transformer model 152 is a deep learning model that operates according to the principle of self-attention (e.g., a computer-specific technique that mimics cognitive attention). For example, the generative transformer model 152 differentially weighs the significance of each part of an input (which includes the recursive output) data, and uses one or more attention mechanism to provide context for any position in the input sequence.

A generalized architecture of a generative transformer model is described below.

### Input:

In general, input data strings are parsed into tokens (e.g., by a byte pair encoding tokenizer). Further, each token is converted via a word embedding into a vector. In some implemtations, positional information of the token can be added to the word embedding.

### Encoder/Decoder Architecture:

In general, a generative transformer model includes a decoder. Further, in some implementations, the generative transformer model can also include an encoder. An encoder includes one or more encoding layers that process the input iteratively one layer after another, while the decoder includes one or more decoding layers that perform a similar operation with respect to the encoder's output.

Each encoder layer is configured to generate encodings that contain information about which parts of the inputs are relevant to each other, and passes these encodings to the next encoder layer as inputs. Each decoder layer performs the functional opposite, by taking all the encodings and using their incorporated contextual information to generate an output sequence. To achieve this, each encoder and decoder layer can make use of an attention mechanism.

For each part of the input, an attention mechanism weights the relevance of every other part and draws from them to produce the output. Each decoder layer has an additional attention mechanism that draws information from the outputs of previous decoders, before the decoder layer draws information from the encodings.

Further, the encoder and/or decoder layers can have a feed-forward neural network for additional processing of the outputs and contain residual connections and layer normalization steps.

As an example, one or more attention mechanism can be configured to implement scaled dot-product attention. For instance, when an input data string is passed into the generative transformer model, attention weights can be calculated between every token simultaneously. An attention mechanism can produce embeddings for every token in context that contain information about the token itself along with a weighted combination of other relevant tokens each weighted by its attention weight.

For each attention unit, the generative transformer model learns three weight matrices; the query weights W_{Q}, the key weights W_{K}, and the value weights W_{V}. For each token i, the input word embedding x₁ is multiplied with each of the three weight matrices to produce a query vector qᵢ=xᵢW_{Q}, a key vector kᵢ=xᵢW_{K}, and a value vector vᵢ=xᵢW_{V}. Attention weights are calculated using the query and key vectors: the attention weight aᵢⱼ from token i to token j is the dot product between qᵢ and kⱼ. The attention weights are divided by the square root of the dimension of the key vectors, \sqrt{dₖ}, which stabilizes gradients during training, and passed through a softmax which normalizes the weights. The fact that W_{Q} and W_{K} are different matrices allows attention to be non-symmetric: if token j (e.g., qᵢ· kⱼ is large), this does not necessarily mean that token j will attend to token i (e.g., qᵢ· kⱼ could be small). The output of the attention unit for token i is the weighted sum of the value vectors of all tokens, weighted by aᵢⱼ, the attention from token i to each token.

The attention calculation for all tokens can be expressed as one large matrix calculation using the softmax function, which is useful for training due to computational matrix operation optimizations that quickly compute matrix operations. The matrices Q, K. and V are defined as the matrices where the ith rows are vectors qᵢ, kᵢ, and vᵢ, respectively. Accordingly, attention can be presented as:

$$Attention ( Q , K , V ) = softmax ( \frac{{QK}^{T}}{\sqrt{{d}_{k}}} ) V$$

where softmax is taken over the horizontal axis.

In general, one set of (W_{Q}, W_{K}, W_{V}) matrices may be referred to as an attention head, and each layer in a generative transformer model can have multiple attention heads. While each attention head attends to the tokens that are relevant to each token, with multiple attention heads the model can do this for different definitions of “relevance.”

In addition, the influence field representing relevance can become progressively dilated in successive layers. Further, the computations for each attention head can be performed in parallel, which allows for fast processing. The outputs for the attention layer are concatenated to pass into the feed-forward neural network layers.

### Encoder:

In general, encoder can include two major components: a self-attention mechanism and a feed-forward neural network. The self-attention mechanism accepts input encodings from the previous encoder and weights their relevance to each other to generate output encodings. The feed-forward neural network further processes each output encoding individually. These output encodings are then passed to the next encoder as its input, as well as to the decoders.

The first encoder takes positional information and embeddings of the input sequence as its input, rather than encodings.

The encoder is bidirectional. Attention can be placed on tokens before and after the current token.

A positional encoding is a fixed-size vector representation that encapsulates the relative positions of tokens within a target sequence.

The positional encoding is defined as a function of type ƒ: R→R^{d}; d ∈ Z, d>0, where d is a positive even integer. The full position encoding can be represented as follows:

$$( {f ( t )}_{2 k} , {f ( t )}_{2 k} + 1 ) = ( sin ( θ ) , cos ( θ ) ) \qquad ∀ k ∈ \{ 0 , 1 , … , d / 2 - 1 \}$$

where θ=ᵣ_{ₖ}^{t}, =N^{2/d}.

Here, N is a free parameter that is significantly larger than the biggest k that would be input into the positional encoding function.

This positional encoding function allows the generative transformation model to perform shifts as linear transformations:

$$f ( t + Δ t ) = diag ( f Δ t ) ) f ( t )$$

where Δt ∈ R is the distance one wishes to shift. This allows the transformer to take any encoded position, and find the encoding of the position n-steps-ahead or n-steps-behind, by a matrix multiplication.

By taking a linear sum, any convolution can also be implemented as linear transformations:

$${\sum }_{j} {c}_{j} f ( t + Δ {t}_{j} ) = ( {\sum }_{j} {c}_{j} diag ( f ( Δ {t}_{j} ) ) ) f ( t )$$

for any constants cⱼ. This allows the transformer to take any encoded position and find a linear sum of the encoded locations of its neighbors. This sum of encoded positions, when fed into the attention mechanism, would create attention weights on its neighbors, much like what happens in a convolutional neural network language model.

Although an example positional encoding technique is described above, in practice, other positional encoding techniques can also be performed, either instead or in addition to those described above. Further, in some implementations, the generative transformer model need not perform positional encoding.

### Decoder:

Each decoder includes three major components: a self-attention mechanism, an attention mechanism over the encodings, and a feed-forward neural network. The decoder functions in a similar fashion to the encoder, but an additional attention mechanism is inserted which instead draws relevant information from the encodings generated by the encoders. This mechanism can also be called the encoder-decoder attention.

Like the first encoder, the first decoder takes positional information and embeddings of the output sequence as its input, rather than encodings. The transformer does not use the current or future output to predict an output, so the output sequence is partially masked to prevent this reverse information flow. This allows for autoregressive text generation. For all attention heads, attention cannot be placed on following tokens. The last decoder is followed by a final linear transformation and softmax layer, to produce the output probabilities.

As described above, in some implementations, the generative transformer model can include an encoder to facilitate product predictions based on additional contextual information (e.g., contextual information regarding the purchases made by one or more other customers). This allows the generative transformer model to make product predictions for a customer more accuracy (e.g., by taking into account both the customer's product selections, as well as based contextual information regarding the purchases made by others). As an example, this additional contextual information can be used to identify seasonal purchasing trends (e.g., due to holiday). Nevertheless, in some implementations, he generative transformer model does not include an encoder (e.g., the generative transformer model can include only a decoder).

Additional information regarding generative transformer models can be found in “Attention Is All You Need,” arXiv: 1706.03762 by Vaswani, et al., the contends of which are incorporated herein in their entirely.

### Example Processes for Training a Generative Transformer Model

In general, various techniques can be formed to train the generative transformer models described herein. An example process is described in further detail below.

### I. Training Data Preparation:

Step 1: Training data is tokenized to generate tokens for each product, end of basket, end of week, other products, and before customer's data begins representation.

Step 2: Position of week is used as a second input to the model.

Step 3: “Items left in basket” are calculated so that it can be fed in the model training to adjust loss calculation.

### II. Data Preparation Process:

a. Input Data Preparation:
   Step 1: transaction data is loaded. Each row in the transaction data is an item in a basket (transaction). Each column in the transaction data includes customer_ID, item_ID, basket_ID, date.
   Step 2: tokens column is created in the transaction data.
   Step 3: an “end of basket” token is added to the transaction data (e.g., in the tokens column) to each basket (e.g., as an extra row)
   Step 4: dates a converted to week numbers in the transaction data.
   Step 5: an “end of week” token is added to each week in the transaction data (e.g., as an extra row)
   Step 6: a token is added to the transaction data in a token column with one-to-one mapping to the product ID.
   Step 7: optically, replace all the least common product tokens in the transaction data by a single “other item” token.
   Step 8: convert “week” in date format into integer in the transaction data, such that the model can identify weeks' positions.
   Step 9: create “items left in basket” for each row in the transaction data, which represents size of basket left to be filled.
   Step 10: sort the transaction data so that items in the same basket are consecutive, in order of items left, followed by end of basket token, followed by zero or more baskets (if any), followed by one or more end week tokens.
b. Batch Preparation for Training:
   Step 1: define fraction of customers required for training and split customers into train and test.
   Step 2: prepare training batches to feed into the model during training iterations:
   Step 2a: create tokens for item, position, and number of items left in the basket.
   Step 2b: adjust “week” to match its relative position, with most recent week in the data starting at 0.

### III. Model Structure and Training:

Step 1: use token and position encodings as inputs to the model, which are fed into token and position embedding layers respectively, followed by multi-head attention block(s), linear normalization and softmax to obtain outputs for each token as probabilities.
a. Hyper-Parameters:

Hyper-parameters for the model can include one or more of the following:
(i) vocabulary size (e.g., number of product tokens, plus a number of special tokens, such as end of basket, end of week, other item, and “before customer's data begins” tokens),
(ii) block size (e.g., the number of items of history to use in both training and inference),
(iii) number of embedding dimensions,
(iv) number of attention heads,
(v) dropout,
(vi) learning rate,
(vii) batch size,
(viii) number of weeks (e.g., total number of weeks used for positional embedding).
   b. Other Training Settings:

Other training settings of the model can include one or more of the following:
(i) the device used for training (CPU vs GPU),
(ii) maximum number of training iterations,
(iii) evaluation interval,
(iv) the number of evaluation iterations,

Step 1: use token and position encodings as inputs to the model, which are fed into token and position embedding layers respectively, followed by multi-head attention block(s), linear normalization and softmax to obtain outputs for each token as probabilities.

Step 2: model loss is calculated by adjusting the cross-entropy loss for each sequence in a batch, weighted by number of items left in the basket. This ensures that the model penalizes inaccurate predictions in larger baskets compared to smaller ones.

The adjusted loss function is:

$${L}^{1} = \sum ( y * log ( p ) ) - ( log ( max ( n , 1 ) ) ) \qquad ( Eq . 1 )$$

where:
L¹: adjusted cross-entropy loss
y: one-hot encoded vector representing the true class (a vector with 1 at the index of the true class and 0 elsewhere)
p: vector of predicted probabilities for each class
n: number of items left in the basket for the input sequence

### Example Processes

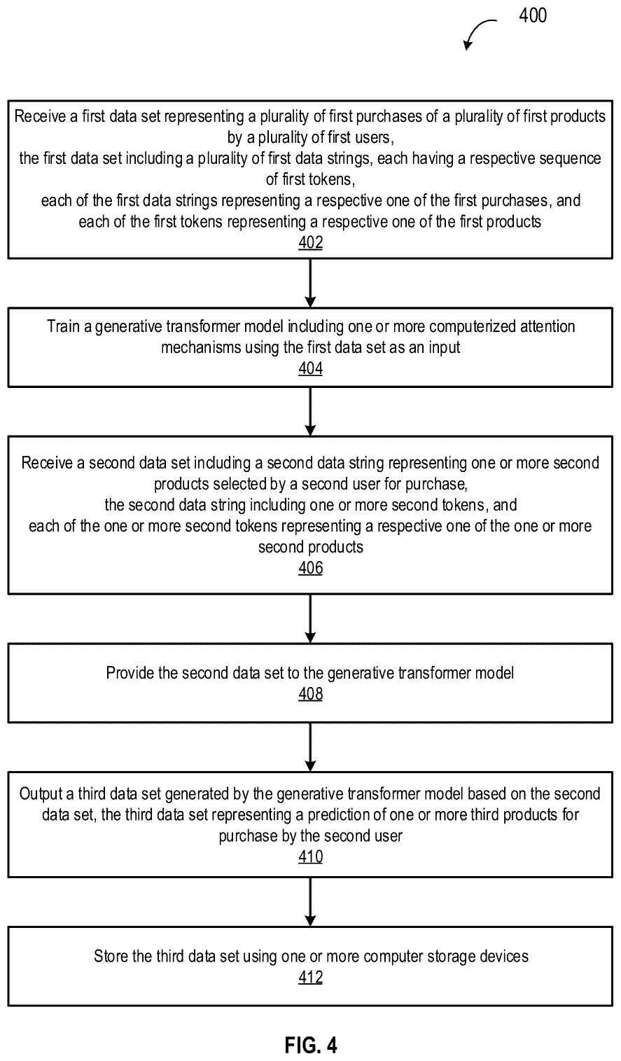

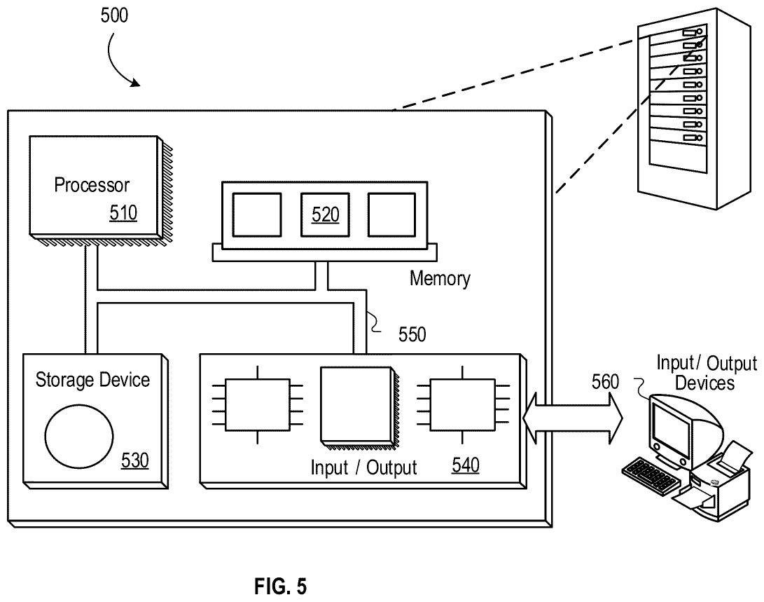

FIG. 4 shows an example process 400 for example process for generating product predictions using a generative transformer model. In some implementations, the process 400 can be performed by the system 100 described in this disclosure (for example, the system 100 including the product prediction engine 150 shown and described with reference to FIGS. 1 and 2) using one or more processors (for example, using the processor or processors 510 shown in FIG. 5).

In the process 400, a system receives a first data set representing a plurality of first purchases of a plurality of first products by a plurality of first users (block 402). The first data set includes a plurality of first data strings, each having a respective sequence of first tokens. Each of the first data strings represents a respective one of the first purchases. Further, each of the first tokens represents a respective one of the first products.

In some implementations, for each of the first data strings, the first tokens of that first data string can be arranged randomly.

In some implementations, for each of the first data strings, the first tokens of that first data string can be arranged sequentially according to one or more first characteristics. The one or more first characteristics can include at least one of a price of a respective one of the first products, a purchase frequency of a respective one of the first products by the first users, a purchase frequency of a respective one of the first products by a respective one of the first users, or an order in which of a respective one of first products was selected for purchase by a respective one of the first users.

In some implementations, the first data set can include first embedded data representing a respective time at which each of the first products was purchased by the first users. In some implementations, the first tokens can include the embedded data. In some implementations, the embedded data and the first tokens can be represented by different respective data structures.

The system trains a generative transformer model including one or more computerized attention mechanisms using the first data set as an input (block 404).

The system receives a second data set including a second data string representing one or more second products selected by a second user for purchase (block 406). The second data string includes one or more second tokens. Further, each of the one or more second tokens represents a respective one of the one or more second products.

In some implementations, the plurality of first users includes the second user. In some implementations, the plurality of first users does not include the second user.

In some implementations, the second data set can represent one or more second products selected by the second user for purchase at an on-line merchant.

In some implementations, the second data set can represent one or more second products selected by the second user for purchase at a physical merchant.

The system provides the second data set to the generative transformer model (block 408). In some implementations, the one or more computerized attention mechanisms can include one or more decoders. In some implementations, the one or more computerized attention mechanisms can include one or more decoders, and one or more encoders.

The system outputs a third data set generated by the generative transformer model based on the second data set (block 410). The third data set represents a prediction of one or more third products for purchase by the second user.

In some implementations, the third data set includes a third data string. The third data string can include one or more third tokens. Further, each of the one or more third tokens can represent a respective one of the one or more third products.

The system stores the third data set using one or more computer storage devices (block 412).

In some implementations, at least one of the first tokens, the one or more second tokens, or the one or more third tokens can include a identifier representing a stock keeping unit (SKU) associated with a respective one of the first products, the one or more second products, or the one or more third products.

In some implementations, at least one of the first tokens, the one or more second tokens, or the one or more third tokens includes a respective token indicating a beginning of at least one of the first data strings, the one or more second data strings, or the one or more third data strings.

In some implementations, at least one of the first tokens, the one or more second tokens, or the one or more third tokens includes a respective token indicating an end of at least one of the first data strings, the one or more second data strings, or the one or more third data strings.

In some implementations, the system can also include cause a message to be presented to the second user. The message can include an indication of at least some of the one or more third products.

In some implementations, the system can also estimate, based on the third data set, a future stock level of the one or more third products.

In some implementations, the system can also receive a fourth data set, where the fourth data set represents one or more fourth products. Further, the system can provide the fourth data set to the generative transformer model, and obtaining a fifth third data set generated by the generative transformer model based on the fourth data set, where the fifth data set represents a prediction of one or more fifth products that are related to the one or more fourth products. Further, the system can store the fifth data set using one or more hardware storage devices. In some implementations, the one or more fourth products can be a subset of the one or more second products.

### Example Systems

Some implementations of the subject matter and operations described in this specification can be implemented in digital electronic circuitry, or in computer software, firmware, or hardware, including the structures disclosed in this specification and their structural equivalents, or in combinations of one or more of them. For example, in some implementations, one or more components of the system 100 (e.g., the product prediction engine 150, the computer system 102, the computer systems 104a-104n, etc.) can be implemented using digital electronic circuitry, or in computer software, firmware, or hardware, or in combinations of one or more of them. In another example, the process 400 shown in FIG. 4 can be implemented using digital electronic circuitry, or in computer software, firmware, or hardware, or in combinations of one or more of them.

Some implementations described in this specification can be implemented as one or more groups or modules of digital electronic circuitry, computer software, firmware, or hardware, or in combinations of one or more of them. Although different modules can be used, each module need not be distinct, and multiple modules can be implemented on the same digital electronic circuitry, computer software, firmware, or hardware, or combination thereof.

Some implementations described in this specification can be implemented as one or more computer programs, that is, one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (for example, multiple CDs, disks, or other storage devices).

The term “data processing apparatus” encompasses all kinds of apparati, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer can also include, or be operatively coupled to receive data from or transfer data to, or both, one or more mass storage devices for storing data, for example, magnetic, magneto optical disks, or optical disks. However, a computer need not have such devices. Devices suitable for storing computer program instructions and data include all forms of non-volatile memory, media and memory devices, including by way of example semiconductor memory devices (for example, EPROM, EEPROM, AND flash memory devices), magnetic disks (for example, internal hard disks, and removable disks), magneto optical disks, and CD-ROM and DVD-ROM disks. The processor and the memory can be supplemented by, or incorporated in, special purpose logic circuitry.

To provide for interaction with a user, operations can be implemented on a computer having a display device (for example, a monitor, or another type of display device) for displaying information to the user. The computer can also include a keyboard and a pointing device (for example, a mouse, a trackball, a tablet, a touch sensitive screen, or another type of pointing device) by which the user can provide input to the computer. Other kinds of devices can be used to provide for interaction with a user as well. For example, feedback provided to the user can be any form of sensory feedback, such as visual feedback, auditory feedback, or tactile feedback. Input from the user can be received in any form, including acoustic, speech, or tactile input. In addition, a computer can interact with a user by sending documents to and receiving documents from a device that is used by the user. For example, a computer can send webpages to a web browser on a user's client device in response to requests received from the web browser.

A computer system can include a single computing device, or multiple computers that operate in proximity or generally remote from each other and typically interact through a communication network. Examples of communication networks include a local area network (“LAN”) and a wide area network (“WAN”), an inter-network (for example, the Internet), a network including a satellite link, and peer-to-peer networks (for example, ad hoc peer-to-peer networks). A relationship of client and server can arise by virtue of computer programs running on the respective computers and having a client-server relationship to each other.

FIG. 5 shows an example computer system 500 that includes a processor 510, a memory 520, a storage device 530 and an input/output device 540. Each of the components 510, 520, 530 and 540 can be interconnected, for example, by a system bus 550. The processor 510 is capable of processing instructions for execution within the system 500. In some implementations, the processor 510 is a single-threaded processor, a multi-threaded processor, or another type of processor. The processor 510 is capable of processing instructions stored in the memory 520 or on the storage device 530. The memory 520 and the storage device 530 can store information within the system 500.

The input/output device 540 provides input/output operations for the system 500. In some implementations, the input/output device 540 can include one or more of a network interface device, for example, an Ethernet card, a serial communication device, for example, an RS-232 port, or a wireless interface device, for example, an 802.11 card, a 3G wireless modem, a 4G wireless modem, or a 5G wireless modem, or both. In some implementations, the input/output device can include driver devices configured to receive input data and send output data to other input/output devices, for example, keyboard, printer and display devices 560. In some implementations, mobile computing devices, mobile communication devices, and other devices can be used.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable sub-combination.

A number of embodiments have been described. Nevertheless, various modifications can be made without departing from the spirit and scope of the invention. Accordingly, other embodiments are within the scope of the claims.

1. A method comprising:
receiving, by one or more processors, a first data set representing a plurality of first purchases of a plurality of first products by a plurality of first users,
wherein the first data set comprises a plurality of first data strings, each having a respective sequence of first tokens,
wherein each of the first data strings represents a respective one of the first purchases, and
wherein each of the first tokens represents a respective one of the first products;
training, by the one or more processors, a generative transformer model including one or more computerized attention mechanisms using the first data set as an input;
receiving, by one or more processors, a second data set comprising a second data string representing one or more second products selected by a second user for purchase,
wherein the second data string comprises one or more second tokens, and
wherein each of the one or more second tokens represents a respective one of the one or more second products;
providing, by the one or more processors, the second data set to the generative transformer model;
outputting, by the one or more processors, a third data set generated by the generative transformer model based on the second data set, wherein the third data set represents a prediction of one or more third products for purchase by the second user; and
storing, by the one or more processors, the third data set using one or more computer storage devices.

2. The method of claim 1, wherein the plurality of first users comprises the second user.

3. The method of 1, wherein the third data set comprises a third data string, wherein the third data string comprises one or more third tokens, and wherein each of the one or more third tokens represents a respective one of the one or more third products.

4. The method of claim 3, wherein at least one of the first tokens, the one or more second tokens, or the one or more third tokens comprises:
a identifier representing a stock keeping unit (SKU) associated with a respective one of the first products, the one or more second products, or the one or more third products.

5. The method of claim 3, wherein at least one of the first tokens, the one or more second tokens, or the one or more third tokens comprises:
a respective token indicating a beginning of at least one of the first data strings, the one or more second data strings, or the one or more third data strings.

6. The method of claim 3, wherein at least one of the first tokens, the one or more second tokens, or the one or more third tokens comprises:
a respective token indicating an end of at least one of the first data strings, the one or more second data strings, or the one or more third data strings.

7. The method of claim 3, wherein for each of the first data strings, the first tokens of that first data string are arranged randomly.

8. The method of claim 3, wherein for each of the first data strings, the first tokens of that first data string are arranged sequentially according to one or more first characteristics.

9. The method of claim 8,
wherein the one or more first characteristics comprises at least one of:
a price of a respective one of the first products,
a purchase frequency of a respective one of the first products by the first users,
a purchase frequency of a respective one of the first products by a respective one of the first users, or
an order in which of a respective one of first products was selected for purchase by a respective one of the first users.

10. The method of claim 3, wherein the first data set comprises first embedded data representing a respective time at which each of the first products was purchased by the first users.

11. The method of claim 10, wherein the first tokens comprise the embedded data.

12. The method of claim 10, wherein the embedded data and the first tokens are represented by different respective data structures.

13. The method of claim 1, wherein the second data set represents one or more second products selected by the second user for purchase at an on-line merchant.

14. The method of claim 1, wherein the second data set represents one or more second products selected by the second user for purchase at a physical merchant.

15. The method of claim 1, further comprising:
causing a message to be presented to the second user, wherein the message comprises an indication of at least some of the one or more third products.

16. The method of claim 1, further comprising:
estimating, based on the third data set, a future stock level of the one or more third products.

17. The method of claim 1, further comprising:
receiving a fourth data set, wherein the fourth data set represents one or more fourth products;
providing the fourth data set to the generative transformer model;
obtaining a fifth third data set generated by the generative transformer model based on the fourth data set, wherein the fifth data set represents a prediction of one or more fifth products that are related to the one or more fourth products; and
storing the fifth data set using one or more hardware storage devices.

18. The method of claim 17, wherein the one or more fourth products is a subset of the one or more second products.

19. The method of claim 1, wherein the one or more computerized attention mechanisms comprises one or more decoders.

20. The method of claim 1, wherein the one or more computerized attention mechanisms comprises:
one or more decoders, and
one or more encoders.

21. A system, comprising:
at least one processor; and
a memory communicatively coupled to the at least one processor, the memory storing instructions which, when executed by the at least one processor, cause the at least one processor to perform operations comprising:
receiving a first data set representing a plurality of first purchases of a plurality of first products by a plurality of first users,
wherein the first data set comprises a plurality of first data strings, each having a respective sequence of first tokens,
wherein each of the first data strings represents a respective one of the first purchases, and
wherein each of the first tokens represents a respective one of the first products;
training a generative transformer model including one or more computerized attention mechanisms using the first data set as an input;
receiving a second data set comprising a second data string representing one or more second products selected by a second user for purchase,
wherein the second data string comprises one or more second tokens, and
wherein each of the one or more second tokens represents a respective one of the one or more second products;
providing the second data set to the generative transformer model;
outputting a third data set generated by the generative transformer model based on the second data set, wherein the third data set represents a prediction of one or more third products for purchase by the second user; and
storing the third data set using one or more computer storage devices.

22. One or more non-transitory computer-readable media storing instructions which, when executed by at least one processor, cause the at least one processor to perform operations comprising:
receiving a first data set representing a plurality of first purchases of a plurality of first products by a plurality of first users,
wherein the first data set comprises a plurality of first data strings, each having a respective sequence of first tokens,
wherein each of the first data strings represents a respective one of the first purchases, and
wherein each of the first tokens represents a respective one of the first products;
training a generative transformer model including one or more computerized attention mechanisms using the first data set as an input;
receiving a second data set comprising a second data string representing one or more second products selected by a second user for purchase,
wherein the second data string comprises one or more second tokens, and
wherein each of the one or more second tokens represents a respective one of the one or more second products:
providing the second data set to the generative transformer model;
outputting a third data set generated by the generative transformer model based on the second data set, wherein the third data set represents a prediction of one or more third products for purchase by the second user; and
storing the third data set using one or more computer storage devices.
